(19) United States
(12) Patent Application Publication
(10) Pub. No.: US 2006/0226318 A1
(43) Pub. Date: Oct. 12, 2006

(54) Installation bracket with level

(76) Inventor: Michael D'Amico, Union, CT (US)

Correspondence Address: LITMAN LAW OFFICES, LTD, PO BOX 15035, CRYSTAL CITY STATION, ARLINGTON, VA, 22215, US

(21) Appl. No.: 11/099,665

(22) Filed: Apr. 6, 2005

(51) Int. Cl. G12B 9/00; E04G 3/00

(52) U.S. Cl. 248/274.1

(57) ABSTRACT

The installation bracket with level is used during the installation of heavy electrical boxes. The bracket has a wall plate and a support plate, with the plates connected to each other by at least one hinge. The wall plate includes mounting holes for mounting the bracket to a wall with support screws. The bracket includes a spirit level that allows the user to correctly align the bracket before mounting the bracket to the wall. The support plate has magnets on its bottom surface to hold the electrical box in a correctly aligned manner against a wall while the electrical box is being installed. This allows the user to install the electrical box without having to support the box manually.

### BACKGROUND OF THE INVENTION

1. Field of the Invention

The present invention relates to hanging devices. More specifically, the invention is an installation bracket with level that provides a temporary support for facilitating hanging large or heavy objects on a wall in a level orientation.

2. Description of the Related Art

Many electricians work alone or for small businesses with few employees. The electricians travel to job sites and install or repair electrical wiring, including the hardware used to connect the electrical wiring into a power source. Electricians often are called upon to install large or heavy hardware, such as steel electrical boxes, panel boards and disconnect switches, while working at a job site. These heavy items must be installed in a level orientation on vertical walls.

It can be difficult for an electrician working alone to lift, level, and secure these heavy items to a vertical surface. The electrical boxes must be secured using multiple screws. An electrician working alone must lift the heavy electrical box off the ground and raise it to the correct location on the wall where it is to be installed. The electrician must then use a spirit level to level the box while holding it against the wall. Then, the electrician must use a power drill to screw multiple screws through the back of the electrical box to secure the box to the wall, while simultaneously supporting the box and keeping it perfectly level.

Various devices have been proposed for mounting items to a wall or other vertical support surface. A representative device is shown in United Kingdom Patent No. 2,227,656, published Aug. 8, 1990, which shows an article-hanging device featuring a flange and projections that are received into a recess so that the face of the main body confronting the picture is flush. International Patent No. 93/25126, published Dec. 23, 1993, describes an assembly for suspending objects, such as prints, on a rail. The assembly has a vertical wire, a hook and an anchoring block. A web page published at www.attach-it.com, at least as of Jan. 27, 2005, teaches various wall mounting brackets that are fastened into the back of the object to be hung by nails or screws and that have markets a bubble level that attached to the glass of a picture frame adjusting the frame until it is level, and then pushing the frame until the prongs pierce the drywall to support the picture frame.

None of the above inventions and patents, taken either singly or in combination, is seen to describe the instant invention as claimed. Thus, an installation bracket with level solving the aforementioned problems is desired.

### SUMMARY OF THE INVENTION

The installation bracket with level is used during the installation of heavy electrical boxes, such as main distribution or entrance panel boxes that house circuit breakers or fuses. The bracket has a wall plate and a support plate, with the plates or leaves connected to each other by a hinge or hinges. The wall plate includes mounting holes, through which support screws are inserted to mount the bracket to a wall. The bracket includes a spirit level that allows the user to correctly align the bracket before mounting the bracket to the wall. The support plate has magnets on its bottom surface to hold the electrical box in a correctly aligned manner against a wall the user to install the electrical box without having to support the box manually.

These and other features of the present invention will become readily apparent upon further review of the following specification and drawings.

### BRIEF DESCRIPTION OF THE DRAWINGS

FIG. 1 is an environmental, perspective view of an installation bracket with level according to the present invention.

FIG. 2 is a perspective view of an installation bracket with level according to the present invention.

FIG. 3 is a front view of an installation bracket with level according to the present invention.

FIG. 4 is a perspective view of an installation bracket with level according to the present invention with the bracket folded for storage.

FIG. 5 is a perspective view of an installation bracket with a laser level and power supply according to the present invention.

Similar reference characters denote corresponding features consistently throughout the attached drawings.

### DETAILED DESCRIPTION OF THE PREFERRED EMBODIMENTS

The present invention is an installation bracket, designated generally as 10 in the figures, that is used during the installation of electrical panel boxes B.

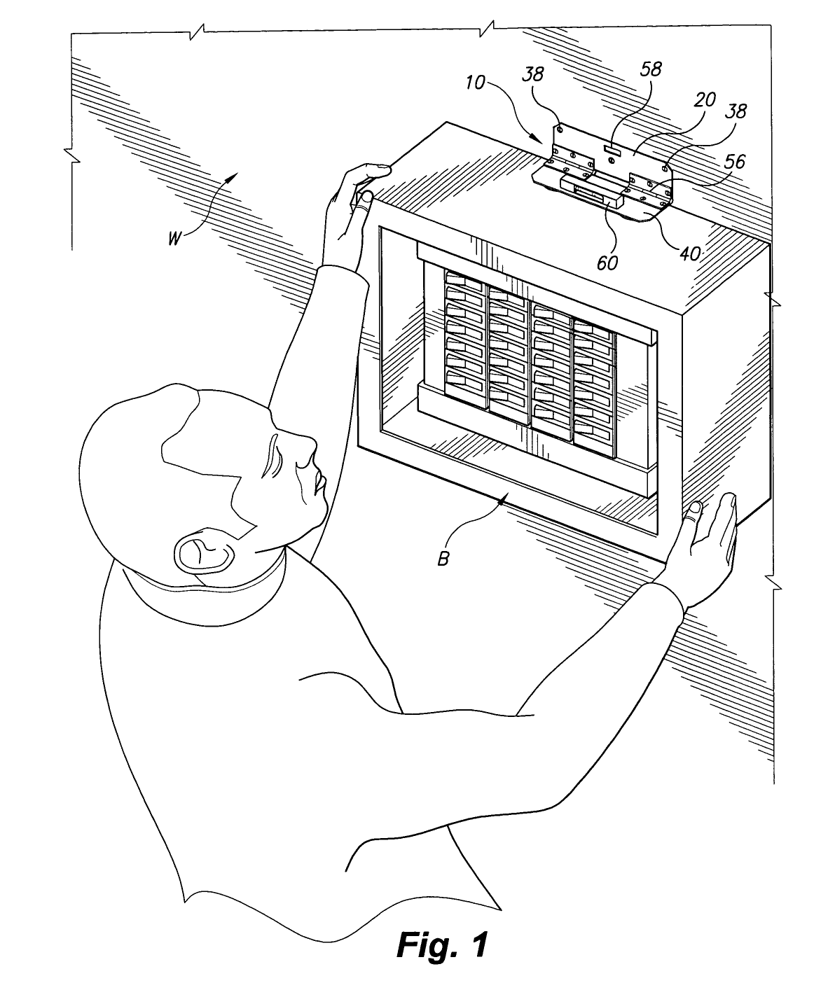

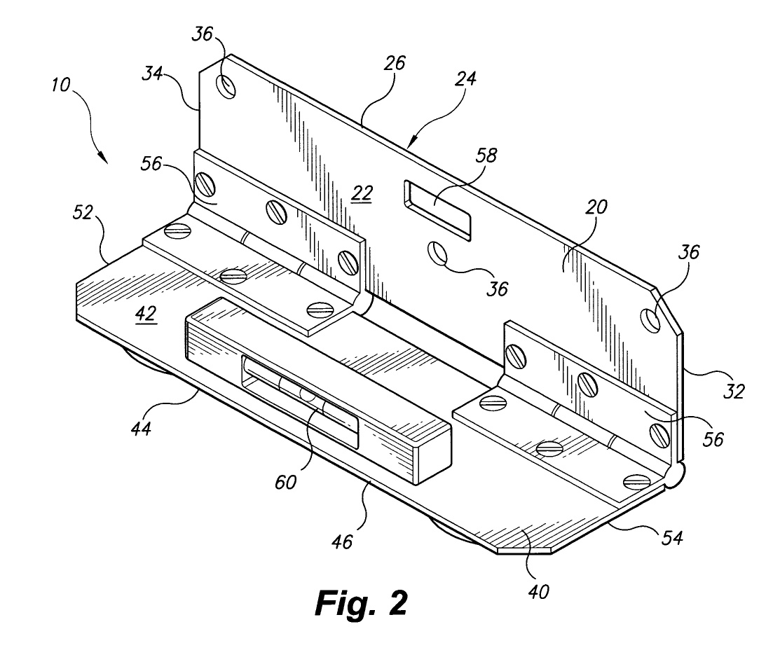

As shown in FIGS. 1 and 2, the bracket 10 has a wall plate 20 having a front surface 22, a back surface 24, a top edge 26, a bottom edge, a right edge 32 and a left edge 34. The wall plate 20 includes mounting holes 36, through which support screws 38 are inserted to mount the bracket 10 to a wall W. The mounting holes 36 pass through the wall plate 20 from the front surface 22 to the back surface 24. The mounting holes 36 should be arranged so that the support screws 38, when installed, provide balanced support to the wall plate 20.

The installation bracket 10 also includes a support plate 40, having a top surface 42, a bottom surface 44, a front edge 46, a rear edge 48, a left edge 52 and a right edge 54, as shown in FIGS. 2-4. The support plate 40 may be positioned normally to the wall plate 20, with the plates connected to each other, either in a fixed manner, such as by welding, gluing or with other fasteners, or the plates may be pivotally connected by one or more hinges 56. The hinges 56 may connect the rear of the support plate 40 to the bottom of the wall plate 20.

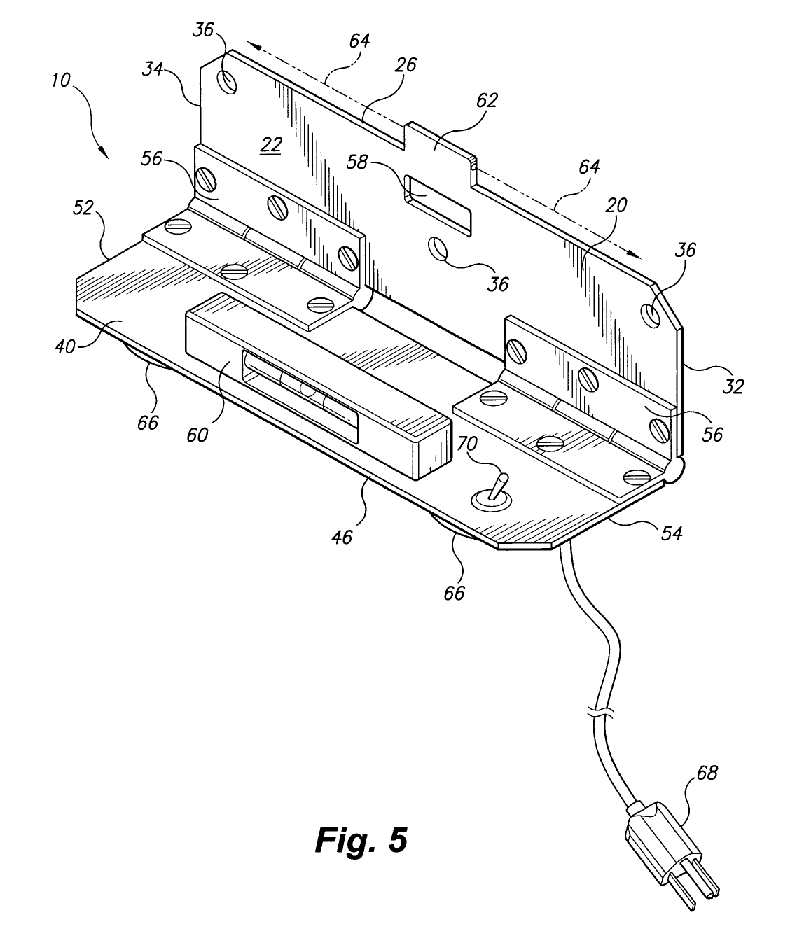

The bracket 10 includes a spirit or bubble level 60 that allows the user to correctly align the bracket 10 before mounting the bracket 10 to the wall W. The spirit level 60 may be disposed on the top surface 42 of the support plate 40 or on the top surface 22 of the wall plate 20. Additionally, a laser level 62, shown in FIG. 5, may be used to project a straight horizontal laser beam 64 along the wall W. The laser level 62 may be separate from the spirit level 60, or may be incorporated into the spirit level 60 housing. The laser level 62 may also be disposed on the top surface 42 of the support plate 40 or along the top edge 26 of the wall plate 20.

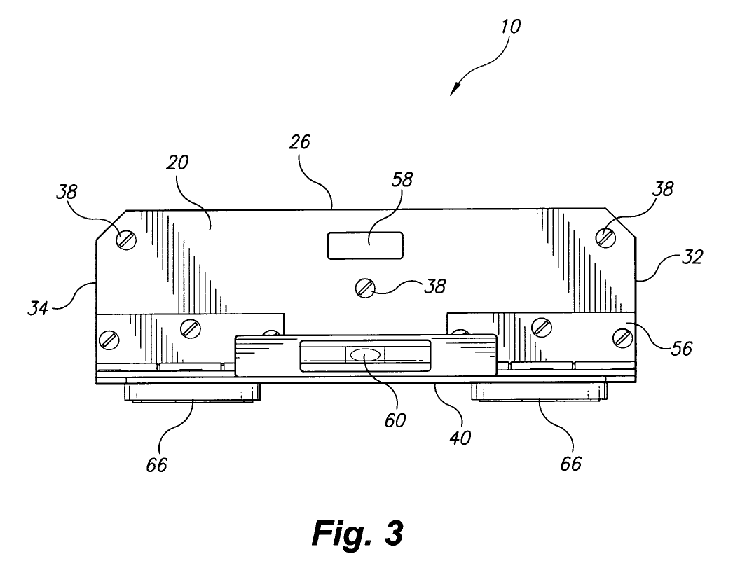

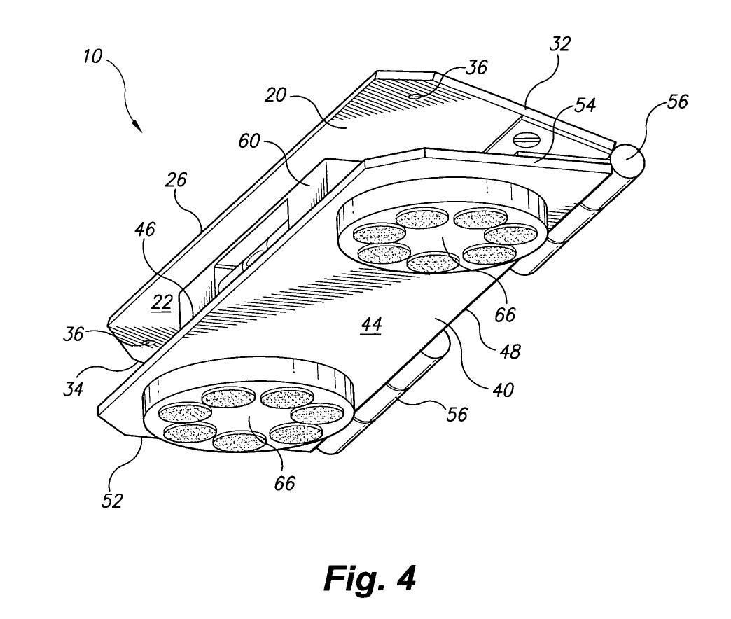

The support plate 40 has magnets 66 fixed to the bottom surface 44, as shown in FIGS. 3 and 4, to hold the electrical box B in a correctly aligned manner against a wall W while the electrical box B is being installed. The magnets 66 may be permanent steel cup magnets or electromagnets. Preferably the magnet(s) are capable of supporting a box weighing up to three hundred pounds suspended above the floor. Additionally, any other temporary fastener that may hold a heavy object in a level manner may be used to support the electrical box B.

The wall plate 20 may additionally have defined in it a slot 58 that allows the user to pry open the bracket 10 if permanent magnets and hinges 56 are used. The slot 58 may also be used to allow the user to grasp the bracket 10 more easily.

The electromagnets 66 and laser level 62 are connected to a power supply, as shown in FIG. 5, such as an AC wall outlet or a portable battery pack, by a power cord 68. The power cord 68 may be retractable. A switch 70 may be used to turn the power for the electromagnets 66 and laser level 62 on or off.

In use, the back surface 24 of the wall plate 20 is placed flush against the wall W while the user horizontally aligns the wall plate 20 using the spirit level 60, as shown in FIG. 1. The wall plate 20 is then secured to the wall W by inserting screws 38 through the mounting holes 36. The user then raises the electrical box B or other object to the desired position against the wall W and secures the electrical box B to the magnets 66, supporting the electrical box B from the support plate 40. Once the electrical. box B is supported by the bracket 10, the user may release the electrical box B and use both hands in securing the electrical box B to the wall W.

Because the installation bracket 10 is horizontally level, the electrical box B is aligned in a horizontally level manner while the user secures it to the wall W. The user may then remove the installation bracket 10 from the wall W by unscrewing the support screws 38. The installation bracket 10 may then be removed from the electrical box B by either sliding or prying it off, if permanent magnets are used, or by shutting off the power to the electromagnets if electromagnets are used. This method allows the user to install the electrical box B without having to support the box manually while performing the installation. The bracket 10 may be folded for compact storage, as shown in FIG. 3.

It is to be understood that the present invention is not limited to the embodiments described above, but encompasses any and all embodiments within the scope of the following claims.

I claim:

1. An installation bracket, comprising:
a wall plate adapted for attachment to a wall;
a support plate attached to and capable of extending substantially normal from the wall plate;
a level attached to one of the plates oriented for adjusting the plates so that the support plate extends parallel to a floor; and
means for temporarily supporting an object to be mounted on the wall level with the floor from the support plate.

2. The installation bracket according to claim 1, wherein said level comprises a spirit level.

3. The installation bracket according to claim 2, wherein said spirit level is attached to said support plate.

4. The installation bracket according to claim 2, wherein said spirit level is attached to said wall plate.

5. The installation bracket according to claim 1, wherein said level comprises a laser level.

6. The installation bracket according to claim 5, wherein said laser level is attached to said support plate.

7. The installation bracket according to claim 5, wherein said laser level is attached to said wall plate.

8. The installation bracket according to claim 1, wherein said support plate is immovably fixed to said wall plate and extends substantially normal thereto.

9. The installation bracket according to claim 1, further comprising at least one hinge formed between said support plate and said wall plate, said support plate pivoting between a storage position substantially parallel to said wall plate and a mounting position substantially normal to said wall plate.

10. The installation bracket according to claim 1, wherein said means for temporarily supporting an object comprises at least one magnet fixed to said support plate.

11. The installation bracket according to claim 10, wherein said magnet has sufficient strength for retaining an object weighing up to three hundred pounds above the floor.

12. The installation bracket according to claim 10, wherein said wall plate has at least one slot defined therethrough.

13. The installation bracket according to claim 10, wherein said magnet comprises an electromagnet.

14. A method for installing an object to a wall, comprising the steps of:
providing an installation bracket with a wall plate, a support plate normal to said wall plate, a level fixed to said bracket, and means for temporarily depending said object from said support plate;
aligning said bracket against the wall with the support plate in a horizontally level position using said level;
attaching said wall plate to the wall;
raising said object against the wall;
temporarily attaching said object to said support plate;
securing said object to the wall, said object being aligned in a horizontally level manner;
detaching said wall plate from the wall; and
detaching said bracket from the object.
